(19) United States
(12) Patent Application Publication
(10) Pub. No.: US 2008/0174121 A1
(43) Pub. Date: Jul. 24, 2008

(54) Gravitational magnetic energy convertor

(76) Inventor: Scott Wattenbarger, Bakersfield, CA (US)

Correspondence Address: STETINA BRUNDA GARRED & BRUCKER, 75 ENTERPRISE, SUITE 250, ALISO VIEJO, CA, 92656, US

(21) Appl. No.: 11/656,679

(22) Filed: Jan. 23, 2007

(51) Int. Cl. H02K 7/18; F03G 7/08

(52) U.S. Cl. 290/1 R; 310/152

(57) ABSTRACT

There is provided a device capable of utilizing magnetic and gravitational forces to generate electrical energy. The device includes a base having a generator coupled thereto. The generator includes a shaft capable of rotating to generate electrical energy. The device further includes a circular frame having an inner perimeter. The circular frame is coupled to the base. The circular frame includes a first magnet coupled thereto. The device additionally includes an arm coupled to the generator shaft. The arm rotates within the circular frame inner perimeter. The arm includes a hammer head having a second magnet. The polarity of the second magnet is similar to the polarity of the first magnet. The first magnet is positioned such that the similar polarities of the first and second magnet create a force which propels the arm in the direction of rotation.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND

This invention relates in general to a power converting device. In particular, the present invention utilizes gravitational forces and magnetic forces to generate electrical energy.

Energy consumption is a very important issue in today's society. Currently, fossil fuels serve as the world's leading energy source. Although fossil fuels have served as a successful source of power for many years, there are inherent problems associated with fossil fuels upon combustion, including the by-product of pollution and exhaust that may be detrimental to the environment. Moreover, and separate and apart from the harmful affects of fossil fuel consumption, is the depletion of the world's fossil fuel supply. It is widely believed that the present supply of fossil fuels is quickly diminishing with many projections indicating that at the current rate of consumption, the supply of fossil fuels will be completely depleted in a matter of decades. Because the world has become very dependant on fossil fuels as an energy source, coupled with the unstable geopolitical environment of many oil producing nations, there is a substantial need to find an alternative energy source before completely depleting the world's reserves of fossil fuels.

The above-identified concerns have provided the impetus to create alternative forms of energy. There have been many attempts to develop an alternative energy source to replace the world's depleting supply of fossil fuels. A large number of these attempts are based on the concept of converting mechanical energy into electrical energy. Windmills and water-driven generators are exemplary of such attempts to convert mechanical energy into electrical energy. Although windmills and water-driven generators are capable of successfully convert mechanical energy into electrical energy, they are dependant on external elements, namely wind and water. As such, they cannot be relied upon as a dependable energy source.

In view of the foregoing, the force of gravity has been studied to determine whether it may be used as a possible source of energy. A gravitational field surrounds the Earth and applies a constant force at the Earth's surface. The gravitational field is numerically quantified by the acceleration of objects under its influence. The gravitational acceleration caused by the Earth's gravitational field is approximately equal to 9.8 m/s² or 32.17 ft/s².

In addition, considerable effort has been devoted to understanding magnets to determine whether they may serve as a source of energy. Magnets are objects that produce a magnetic field. There are two types of magnets; in particular, permanent magnets and electromagnets. Permanent magnets do not rely on an external influence to create their magnetic field. Conversely, electromagnets rely on an external current to create their field. Magnets are polar, with like poles repelling each other, and dissimilar poles attracting each other. The force of attraction generated by two magnets is represented by Coulomb's Law, which states that the force of attraction (F) is proportional to the attractive force of one magnet (M₁) multiplied by the attractive force of a second magnet (M₂) divided by the square of the distance between the two magnets (d²), or as written in equation format,

$$F = \frac{{M}_{1} {M}_{2}}{{d}^{2}} .$$

Although magnetic and gravitational forces have been known for a long time, they have not been effectively utilized to generate energy. As such, there is a need in the art for a device that is capable of generating energy by harnessing the forces caused by gravity as well as magnetic forces.

### BRIEF SUMMARY

According to an aspect of the present invention, there is provided a device capable of utilizing magnetic forces as well as gravitational forces to generate electrical energy. The device includes a base having a generator coupled thereto. The generator includes a shaft capable of rotating, such that as the shaft rotates, the generator produces electrical energy. The device further includes a circular frame having an inner perimeter. The circular frame is coupled to the base. The circular frame includes a first magnet coupled thereto. The device additionally includes an arm coupled to the generator shaft. The arm has a length that is smaller than the diameter of the circular frame inner perimeter, thereby allowing the arm to rotate within the circular frame inner perimeter. The arm also includes a hammer head having a second magnet. The polarity of the second magnet is similar to the polarity of the first magnet. The first magnet is positioned such that the similar polarities of the first and second magnet create a force which propels the arm in the direction of rotation.

The present invention is particularly useful given the above-mentioned shortcomings of fossil fuels. The device effectively combines gravitational forces with magnetic forces to generate energy. Gravity and magnetic forces effectively combine to provide continuous rotation of the arm for as long a duration as possible. While it is understood that the motion system will encounter forces such as friction and other external elements that may ultimately slow or stop the motion system, it is contemplated that the combination of such features will provide a motion system that can operate for a substantially longer period than those known in the art.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of the gravitational, magnetic energy generation device.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

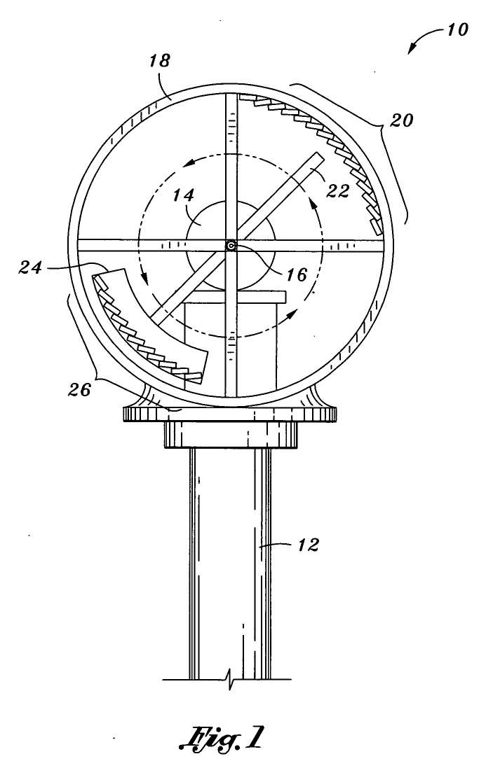

Referring now to the drawing, FIG. 1 illustrates an embodiment of the present invention. The device 10 includes a base 12 and a generator 14 coupled to the base 12. The generator 14 includes a shaft 16 which is capable of rotating. The generator 14 is capable of converting the mechanical rotation of the shaft 16 into electrical energy. The present invention utilizes gravitational forces and magnetic forces which cause rotation of the generator shaft 16, thereby creating the electrical energy.

Attached to the generator shaft 16 is an arm 22. The arm 22 includes a hammer head 24 that is of considerable weight. The arm 22 rotates within a circular frame 18, which is also coupled to the base 12. The circular frame 18 includes an inner perimeter having a diameter that is larger than the length of the arm 22. A first magnet 20 is coupled to the circular frame 18, and a second magnet 26 is coupled to the hammer head 24. In general, magnets are materials having two poles. Sometimes the poles are referred to as north and south, while other times they may be referred to as positive and negative. When two magnets are placed in close proximity to each other, a magnetic force is created. Magnetic ends having opposite polarities are attracted to each other. Conversely, magnetic ends having similar polarities are repelled from each other.

The first and second magnets 20, 26 are arranged such that the adjacent ends of the first and second magnets 20, 26 have similar polarities. In other words, the first and second magnets 20, 26 are arranged such that either the northern ends of the first and second magnets 20, 26 are adjacent to each other, and/or the southern ends of the first and second magnets 20, 26 are adjacent to each other.

In operation, the arm 22 rotates within the circular frame 18 thereby causing the generator shaft 16 to rotate. According to one embodiment, the circular frame 18 is divided into four quadrants; namely, the first, second, third and fourth quadrants. The first quadrant is defined as the quadrant wherein gravitational forces begin to cause the hammer head 24 to accelerate. Gravity continues to cause the hammer head 24 to accelerate through the second quadrant. In the third quadrant, the hammer head 24 begins to rotate in a direction opposing the force of gravity. As such, the rotational speed of the arm 22 begins to decrease. The fourth quadrant is the portion of the circular frame located between the third and first quadrants.

As gravity causes the hammer head 24 to accelerate, the shaft 16 rotation also accelerates. However, a frictional force is applied to the generator shaft 16 in the direction opposing rotation. In order to achieve rotation of the generator shaft 16, the moment caused by the gravitational force must be larger than the frictional force. Gravity causes the arm 22 to rotate through the first and second quadrants; however, as the hammer head 24 rotates into the third quadrant of the circular frame 18, the gravitational and frictional forces cause the arm 22 to decelerate. The momentum of the hammer head 24, after rotating through the first and second quadrants, is not sufficient to overcome the gravitational and frictional forces to carry the hammer head 24 completely through the third and fourth quadrants. As such, the arm 22 would completely stop rotating before completing a full rotation. In order for the arm to complete a rotation, an external force must act on the arm. The magnetic force created by the first and second magnet 20, 26 provides a sufficient external force to propel the arm 22 through the remainder of its rotation.

The magnetic force created between the first and second magnets 20, 26 must sufficiently counteract the gravitational and frictional forces, and also accelerate the arm 22 through the fourth quadrant of the circular frame 18. The magnetic force (F) created

$$F = \frac{{M}_{1} {M}_{2}}{{d}^{2}} ,$$

by the first and second magnets is equal to where M₁ is the attractive force of the first magnets 20, M₂ is the attractive force of the second magnets 26, and d² is the square of the distance between the first and second magnets 20, 26. Therefore, the magnetic force may be increased using magnets with a greater attractive force, or by decreasing the distance between the first and second magnets 20, 26.

According to one embodiment, the first and/or second magnets 20, 26 are permanent magnets. A permanent magnet is a magnet that does not rely on an outside influence to create its magnetic field. In another embodiment of the invention, it is contemplated that the first and/or second magnets 20, 26 are electromagnets. Electromagnets rely on an electric current in order to create a magnetic field. The strength of an electromagnetic field may be increased by increasing the electric current. In addition, the polarity of the electromagnet can be changed by changing the direction of the electric current.

It is contemplated that the present invention may be used in a variety of different applications. As such, the size of the device 10 may be tailored according to a particular application. For instance, it is envisioned that one embodiment may be used as a home unit to provide power to equipment such as a pool pump. Another embodiment may be a little larger and may serve as a house generator or possibly in an industrial capacity. According to a further embodiment, the device 10 may be larger, such as wind mill size, and may serve as an oil well pump.

The size of the hammer head 24 and/or the size of the first and second magnets 20, 26 may vary depending on the size of the overall device 10. As the weight of the hammer head 24 increases, the force it creates as it rotates through the first and second quadrants also increase. Therefore, if there is a load, or large friction force caused by the generator 14, a heavier hammer head 24 may be used. However, a heavy hammer head 24 will require a larger magnetic force to complete its rotation through the third and fourth quadrants. As such, magnets having a larger attractive force may be employed.

According to one embodiment, the first magnet 20 is comprised of a plurality of magnets coupled to the circular frame 18, as depicted in FIG. 1. The plurality of magnets may be arranged at an angle relative to the circular frame 18 inner perimeter to maximize the force propelling the arm 22 in the direction of rotation. The magnets are located within a magnet zone. The magnet zone is the portion of the circular frame 18 containing magnets. In one particular embodiment, the magnet zone comprises at least one quarter of the circular frame inner perimeter. Although the magnet zone is in the fourth quadrant, as shown in FIG. 1, the magnet zone may be located anywhere along the circular frame 18. In addition, the size and number of magnet zones may vary.

In another embodiment of the invention, the second magnet 26 is comprised of a plurality of magnets, as shown in FIG. 1. The second magnets 26 may be arranged at an angle relative to the first magnet(s) 20 in order to maximize the force propelling the arm 22 in the direction of rotation.

In the embodiment shown in FIG. 1, the arm 22 is rotating in a counter-clockwise manner. However, it is understood that the arm 22 may also rotate in a clockwise manner.

As was stated above, once the center of gravity of the hammer head 24 rotates from the fourth quadrant into the first quadrant, gravity causes the arm 22 to rotate. However, an external force may be needed to place the hammer head 24 within the first quadrant. An external power source, such as a motor may be used, or alternatively a crank may also be used. However, other means of placing the hammer head 24 within the first quadrant that are known or later developed by those having skill in the art may also be utilized.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A gravitational, magnetic energy generation device comprising:
a base;
a generator coupled to the base, the generator having a shaft capable of rotating, such that as the shaft rotates, the generator generates electricity;
a circular frame coupled to the base, the circular frame having an inner perimeter, wherein a first magnet is coupled to the circular frame; and
an arm coupled to the shaft, the arm having a length smaller than the diameter of the circular frame inner perimeter, the arm comprising a hammer head having a second magnet, wherein the polarity of the second magnet is similar to the polarity of the first magnet, the first magnet being positioned such that the similar polarities of the first and second magnet creates a force propelling the arm in the direction of rotation.

2. The energy generation device of claim 1, wherein the first magnet is a permanent magnet.

3. The energy generation device of claim 1, wherein the second magnet is a permanent magnet.

4. The energy generation device of claim 1, comprising a plurality of first magnets located within a magnet zone.

5. The energy generation device of claim 4, wherein the magnet zone comprises at least one-quarter of the circular frame inner perimeter.

6. The energy generation device of claim 5, wherein the circular frame being divided into a first quadrant, second quadrant, third quadrant, and fourth quadrant, wherein gravity causes the arm to accelerate in the first and second quadrant, and gravity causes the arm to begin to decelerate in the third quadrant, the magnet zone being located in the fourth quadrant.

7. The energy generation device of claim 4, wherein the plurality of first magnets are arranged at an angle relative to the circular frame inner perimeter to maximize the force propelling the arm in the direction of rotation.

8. The energy generation device of claim 1, comprising a plurality of second magnets.

9. The energy generation device of claim 8, wherein the plurality of second magnets are arranged at an angle relative to the first magnet in order to maximize the force propelling the arm in the direction of rotation.
